(19) United States
(12) Patent Application Publication
(10) Pub. No.: US 2022/0255814 A1
(43) Pub. Date: Aug. 11, 2022

(54) Network Node and Methods in a Communications Network

(71) Applicant: Telefonaktiebolaget LM Ericsson (publ), Stockholm (SE)

(72) Inventors: Konstantinos Vandikas, Solna (SE); Leonid Mokrushin, Uppsala (SE); Daniel Lindström, Luleå (SE); Marin Orlic, Bromma (SE); Markus Andersson, Boden (SE)

(21) Appl. No.: 17/616,242

(22) PCT Filed: Jun. 3, 2019
(86) PCT No.: PCT/EP2019/064335

§ 371 Date: Dec. 3, 2021

(51) Int. Cl. H04L 41/5054; H04L 41/5041; H04L 41/16

(52) U.S. Cl. CPC H04L 41/5054; H04L 41/16; H04L 41/5045

(57) ABSTRACT

A method performed by a network node for handling one or more upcoming requests for one or more services from a communication device in a communications network using a cloud infrastructure is provided. The network node obtains (301) a prediction of an amount of instances needed for the one or more upcoming requests for the one or more services, based on historical data of previous requests for services, and obtains (304) network connections needed for the one or more upcoming requests for the one or more services, taking the prediction into account. Furthermore, the network node decides (307) to instantiate a service with the obtained network connections and/or the amount of instances as predicted.

### TECHNICAL FIELD

Embodiments herein relate to a network node and methods therein. In particular, they relate to handling upcoming requests for services from a communication device in a communications network using a cloud infrastructure.

### BACKGROUND

In a typical communications network, wireless devices, also known as wireless communication devices, communication devices, mobile stations, stations (STA) and/or user equipment (UE), communicate via a Local Area Network such as a WiFi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5th Generation (5G). A service area or cell area is a geographical area where radio coverage is provided by the radio network node. The radio network node communicates over an air interface operating on radio frequencies with the wireless device within range of the radio network node. The radio network node communicates to the wireless device in DownLink (DL) and from the wireless device in UpLink (UL).

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3rd Generation (3G) networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

In the state of the art, the use of serverless computing is expanding since it offers an affordable approach for deploying software in a cloud environment. Serverless computing when used herein may be said to comprise any kind of function as a service computation where there are essentially no dedicated resources for a particular function or process, and where resources are allocated on demand when a request is being made towards that function or process by an external system over a network interface. A cloud environment when used herein means a network connected pool of computational resources such as Central Processing Unit (CPU) or Random Access Memory (RAM), accompanied by an interface that allows for a declarative interface that enables allocation of such resources to processes, or a pool of resources exposed over a network connection. A cloud environment may also be referred to herein as a cloud infrastructure or a cloud.

The affordability of serverless approaches is essentially a consequence of the fact that service functions are not always active, which means that they do not occupy any space in a CPU or RAM unless there is some request for it. Service functions may also be referred to as lambda functions, lambdas, logical functions, anonymous functions, serverless software, serverless functions etc. Requests when used herein may also be referred to as remote calls or service requests. When a request from a remote node is received by a serverless infrastructure, it is buffered in a request buffer. The requested service function is then loaded by a serverless infrastructure controller and thereafter is served by the individual process that has been allocated by the serverless infrastructure controller for that particular logical function. After a brief period of inactivity, the service function is unloaded from the CPU and the RAM, thus not occupying any resources and therefore not producing any cost to the host of the cloud environment and the owner of the service function. In general, resources in such a case go to an idle state and modern CPUs are optimized not to consume much power while in idle state. Therefore, since the resources are no longer allocated, they may be made available for other service functions. An interesting consequence here is that multiple versions of the same service function may be deployed in a cloud environment without producing any cost unless they are utilized by a user. This means that previous versions of the same service function may be used for backwards-compatibility purposes. For example, in a RESTful API a function will most likely get a URI of the form http://some_ip:some_port/my_function/v1 or v2 etc.

Beyond serverless computing, a similar interaction pattern may be identified when using docker containers and virtual machines.

A docker container is an open source software development platform that uses container technology which is a form of virtualization. A container is a standard unit of software that ensures that application runs from one computing environment to another. The container e.g. comprises code, runtime, system tools, system libraries and settings.

A virtual machine, also referred to as a VM, emulates a computer system and is capable of running applications and programs. One or many virtual machines may be created within another computer environment. The implementations of virtual machines may comprise hardware, software or a combination thereof.

The main difference between serverless computing and docker containers and/or virtual machines is that serverless computing is truly on-demand. Docker containers and virtual machines on the other hand need to be deployed ahead of time in order to be able to serve a request.

Despite the advantages offered by serverless computing, it involves at least two drawbacks, high latency and inability to have persistent connections with other services. Persistent connections, which may also be referred to e.g. as keep-alive, long-lived connections or connection reuse, when used herein corresponds to the concept of using a single connection to send and receive multiple requests/responses, as opposed to opening a new connection for every single request/response pair.

High latency: Since a service function is not in a running state, users need to wait initially until the service function is loaded. Depending on the complexity of the service function this may take time.

Inability to have persistent connections with other services: Service functions cannot handle persistent connections since the persistency is torn down once the service function is evicted from the CPU and/or RAM.

Instructions for persistent connections may be included within the service function but since the state of the connection is not maintained, each connection needs to be rebuilt every time the service function is loaded, thus introducing more latency.

The latency issue is one of the main advocates against using serverless computing despite the advantages offered by the serverless computing approach.

The drawbacks identified above apply to docker containers and virtual machines as well. The delay in cases where docker containers and virtual machines are used is even more prominent if the docker container or virtual machine is not already instantiated. It is particularly inadequate in the case of virtual machines since they are larger than docker images in terms of size.

### SUMMARY

As part of developing embodiments herein the inventors have identified a problem which first will be discussed.

Typically, in the state-of-the-art, load balancers are used to dynamically compensate when a certain service function or virtual machine or docker container is not available for a remote call due to a failure or due to high usage of other similar instances that are meant to serve the same remote call.

Load balancers consider health related metrics in order to decide when to increase or decrease redundant versions of the same instance. Health related metrics may comprise factors such as CPU or memory such as RAM utilization, e.g. if CPU usage exceeds a certain capacity percentage.

Furthermore, in the state of the art, there are predictive approaches that use measurements in order to predict usage of service functions, docker containers and/or virtual machines, and consequently set up or tear down virtual machines.

A drawback with these approaches is that they are mainly focused on declaring what someone expects from an infrastructure, i.e. where to place what, which software to load, what resources to use etc. Such a focus is limiting because it does not allow expressing the level of availability that service functions should have. These approaches are only able to make the service functions constantly available or available on-demand in serverless infrastructures, but still without being able to predict when the service functions will be needed. These approaches do not take into consideration remote requests, only the consequence of the remote request. Thereafter an educated guess is ascertained around increasing or decreasing resource allocation. Moreover, they require a lot of information to be stored due to the nature of supervised and/or unsupervised learning approaches in order to be able to make good predictions.

An object of embodiments herein is to improve the performance of a communications network.

According to a first aspect of embodiments herein, the object is achieved by a method performed by a network node for handling one or more upcoming requests for one or more services from a communication device in a communications network using a cloud infrastructure.

The network node obtains a prediction of an amount of instances needed for the one or more upcoming requests for the one or more services, based on historical data of previous requests for services, and obtains network connections needed for the one or more upcoming requests for the one or more services, taking the prediction into account.

Furthermore, the network node decides to instantiate a service with the obtained network connections and/or the amount of instances as predicted.

According to a second aspect of embodiments herein, the object is achieved by a network node-in the communications network using the cloud infrastructure. The node is configured to handle one or more upcoming requests for one or more services from the communication device.

The network node is further configured to:

Obtain a prediction of an amount of instances needed for the one or more upcoming requests for the one or more services, based on historical data of previous requests for services,

obtain network connections needed for the one or more upcoming requests for the one or more services, taking the prediction into account, and

decide to instantiate a service with the obtained network connections and/or the amount of instances as predicted.

A reduction of latency is achieved since service functions are made readily available when needed and, therefore, service requests do not spend too much resources in the buffer or queue up in the buffer, thus reducing the size of the buffer. Moreover, since the prediction comprises predicting when service functions are not needed, the embodiments herein may be used for the purposes of evicting the service functions, thus releasing resources. Thereby, the performance of the communications network is improved.

An advantage of embodiments herein is that reinforcement learning may be used to make such predictions, which allows the system according to embodiments herein to calibrate itself overtime without storing too much information, as opposed to more conventional machine learning techniques that require large quantities of information.

### BRIEF DESCRIPTION OF THE DRAWINGS

Examples of embodiments herein are described in more detail with reference to attached drawings in which:

FIG. 1 is a schematic diagram illustrating an example of a communications network.

FIGS. 2 a, b, c and d are schematic diagrams illustrating embodiments of components in a communications network.

FIG. 3 is a flowchart depicting embodiments of a method performed by a network node.

FIG. 4 is a sequence diagram depicting embodiments of components in a communications network.

FIGS. 5 a and b are schematic block diagrams illustrating embodiments of a network node.

FIG. 6 schematically illustrates a telecommunication network connected via an intermediate network to a host computer.

FIG. 7 is a generalized block diagram of a host computer communicating via a base station with a user equipment over a partially wireless connection.

FIGS. 8 to 11 are flowcharts illustrating methods implemented in a communication system including a host computer, a base station and a user equipment.

### DETAILED DESCRIPTION

According to embodiments herein, service functions may be predicted and preloaded. To preload service functions e.g. means that software which is necessary for a service is stored in a memory, so that e.g. a CPU may execute it in one or multiple devices.

According to embodiments herein, the access time to service functions is improved, consequently benefiting wired and/or wireless networks and cloud infrastructures.

In addition, network connections are obtained in order to enable persistent connections with other services, e.g. if that is a requirement of the service.

Thus, by having preloaded service functions and retrieved network connections, these are readily accessible to communication devices. This means that e.g. when the communication device sends a request to access a particular service and utilise a network connection, the preloaded service function as well as the retrieved network connection are already available and may be accessed without undue delay.

According to some embodiments, the process of predicting and preloading may be performed by a machine learning process, such as a reinforcement based machine learning process. By using a machine learning process, the accuracy of the predictions will improve over time, thereby improving the performance of the communications network. Although any machine learning technique may be used to implement this kind of prediction, reinforcement learning based techniques have been found to be particularly suitable. This is since reinforcement based techniques use reward functions, which allows the system to calibrate over time, thus self-correcting. Furthermore, techniques such as Q-Learning are beneficial with regards to the volume of data needed.

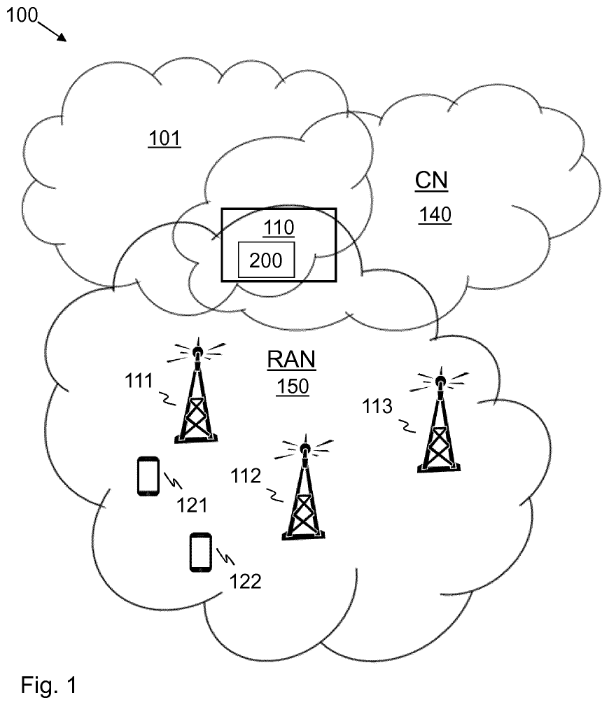

FIG. 1 is a schematic overview depicting a communications network 100 wherein embodiments herein may be implemented. The communications network 100 comprises one or more RANs 150 and one or more CNs 140. The communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

The communications network 100 uses a cloud infrastructure 101, which may be used for performing or partly performing the methods. The cloud infrastructure 101 is e.g. a cloud environment, i.e. a network connected pool of computational resources such as CPU or RAM or pool of resources exposed over a network connection, as defined above.

Software may be deployed in the cloud infrastructure 101 and components may be hosted in the cloud infrastructure 101. The software and/or components may e.g. be used for sending and/or receiving requests to other components in the cloud infrastructure 101 and/or to nodes in the RANs 150 or CNs 140 and/or to communication devices in the RANs 150, which may in turn comprise other components.

A network node 110 operates in the communications network 100. The network node may comprise logical components 200 as described below. The network node 110 may be any type of network node, such as a network node in the RAN 150, a network node in the CN 140, a network node in the cloud infrastructure 101 and/or a distributed node.

As mentioned above a number of different network nodes operate in the communications network 100. The network nodes e.g. the network node 110, may for example be network nodes such as any of the base stations 111, 112, 113, also referred to as the first base station 111, the second base station 112 and the third base station 113. The network nodes 111, 112, 113 may provide radio coverage over a geographical area. The geographical area may be referred to as a cell, a service area, beam or a group of beams. The network nodes 111, 112, 113 may in this case each be a transmission and reception point e.g. a radio access network node such as a base station, e.g. a radio base station such as a NodeB, an evolved Node B (eNB, eNodeB), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a communication device acting as an access point or a peer in a Device to Device (D2D) communication, or any other network unit capable of communicating with a communication unit within the cell served by the network node 111, 112, 113 depending e.g. on the radio access technology and terminology used.

One or more communication devices, such as communication devices 121, 122, also referred to as the first communication device 121 and the second communication device 122, operate in the communications network 100. The communication devices 121, 122 may each e.g. be a mobile station, a non-access point (non-AP) STA, a STA, a user equipment and/or a wireless terminals, an NB-IoT device, an eMTC device and a CAT-M device, a WiFi device, an LTE device and an NR device communicate via one or more Access Networks (AN), e.g. RAN, to one or more core networks (CN). It should be understood that “communication device” is a non-limiting term which means any terminal, wireless communication terminal, wireless device, Device to Device (D2D) terminal, or node e.g. smart phone, laptop, mobile phone, sensor, relay, mobile tablet, a base station communicating within a cell or any device with a network interface, such as an embedded computer.

In some embodiments herein, the network node 110 comprises logical components 200. The network node 110 may in turn, as mentioned above, be comprised in any one or more out of: The cloud infrastructure 101, the RAN 150 and the CN 140. The network node 110 may further be a distributed node. Consequently, the different logical components 200 may be spread in an appropriate manner anywhere in the cloud infrastructure 101, the RAN 150 and the CN 140. A plurality of logical components may be comprised in the same network node 110, or they may be comprised in different network nodes 110 and still maintain a functional connection.

Logical components 200 are utilised in some embodiments herein for serving requests in the cloud infrastructure 101, such as e.g. in a serverless architecture. Using the logical components 200, functions may be preloaded in e.g. the nodes 110 such as e.g. represented by the base stations 111, 112, 113 which may be used by e.g. the communication devices 121, 122. This means that software may be put into a memory so that a CPU may execute it and thereby improve capability. It should be understood that the wording logical component is a non-limiting term, which herein means any component and/or logical function used to perform a specific task. Such a task may e.g. be predicting which function to load next in a serverless infrastructure. The logical component may be said to be a logical function since it may either manifest itself as a piece of software (so that any computer may run it along with other functions) or it may be implemented by way of a dedicated hardware specifically designed for a particular task. Such a dedicated hardware may e.g. be a special purpose machine learning processor such as a Tensorflow Processing Unit and/or other embedded devices too such as NVIDIA Jetson TX2, Google Coral etc.

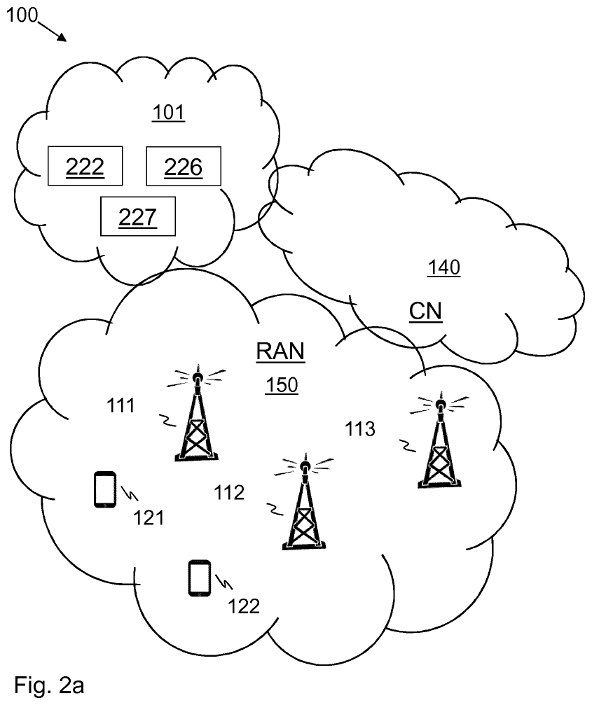

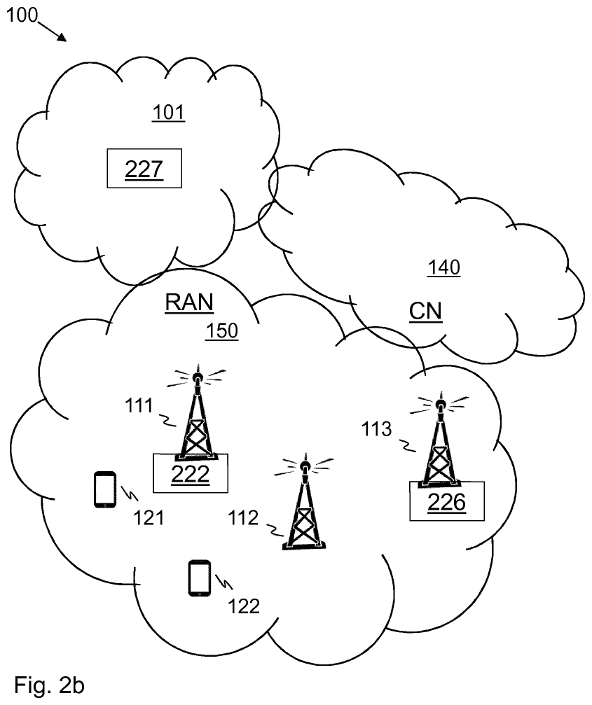

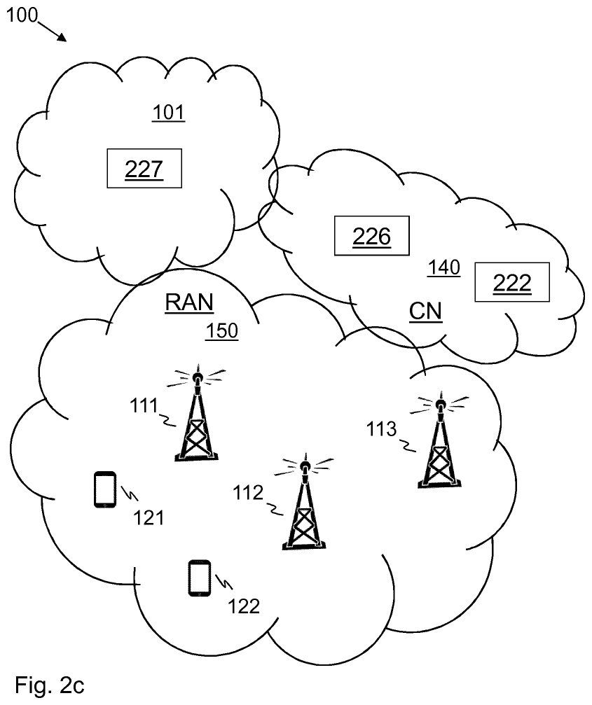

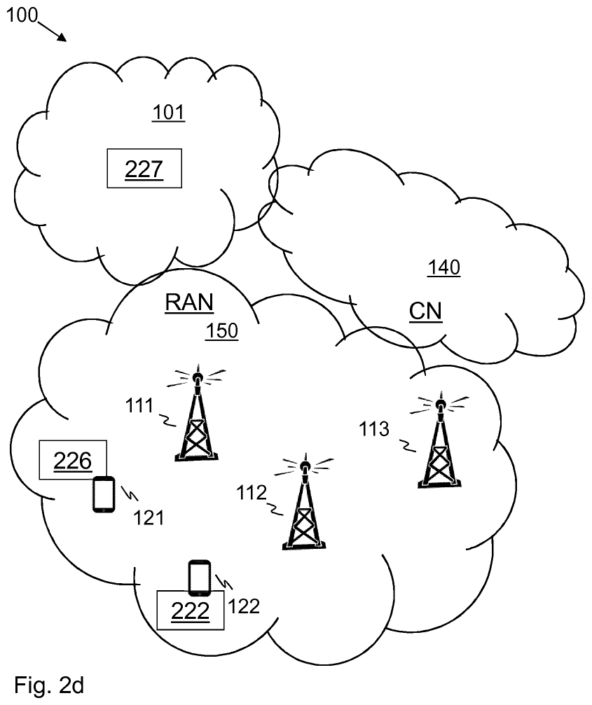

The logical components 200 may e.g. comprise a cluster manager 221, a predictive function 222, a request handler 223, a function repository 224, a runtime component 225, a network connection cache 226 and a database 227. These are described below and shown in FIGS. 2a-d.

The cluster manager 221 may be any type of logical component which is mainly intended to handle requests to allocate software and resources in a cloud, such as the cloud infrastructure 101. Software to be allocated may e.g. be service functions. Resources to be allocated may e.g. be CPU, Memory, RAM, hard disk space, and GPUs.

The cluster manager 221 may e.g. be kubernetes conformant, openstack based or based on docker swarm/docker compose. This means that the cluster manager 221 may be said to be a primary node agent, or lowest level component, that runs on each node and is responsible for what's running on an individual machine. It may for example, if given a set of containers to run, make sure they are all running.

The predictive function 222 may predict when certain serverless functions will be needed, how many copies the certain function will need and how many resources the certain function requires. The predictive function may be governed by an offline process. An offline process, when used herein, may e.g. mean that the process does not have a user interface and as such it periodically performs a task in an automated way without expecting user input. The offline process, may e.g. be represented by a process such as a UNIX™ Daemon that periodically triggers the predictive function 222 in an attempt to predict which function is needed next. The predictive function communicates back to the cluster manager 221 which verifies when the function is loaded in the memory.

The request handler 223 may pick up the predicted function from a function repository 224.

The function repository 224, which may also be referred to as the lambda repository, may store functions in the cloud infrastructure 101, such as e.g. serverless cloud deployments. At the function repository 224 level functions may simply be static binary data.

The runtime component 225 may represent the function or a host of several functions as running process(es). The runtime component 225 may communicate with a network connection cache 226 in order to pick up any network connections that may be needed for the function, instead of recreating them from scratch. In some embodiments herein, the runtime component 225 may also be referred to as a connection handle, since connections may or may not be available at a certain time.

The network connection cache 226, which may also be referred to as a persistent connection cache, may build and store persistent connections that may be needed for a function.

The database 227 may represent any kind of persistent storage, and persistent connections may apply to any remote connection such as e.g. a remote connection to a message queue.

FIGS. 2a-d illustrate some example embodiments of the communications network 100. The embodiments depicted in FIGS. 2a-d show different scenarios comprising some of the logical components 200, located in any one or more out of: The cloud infrastructure 101, the RAN 150 and the CN 140.

An example of some first embodiments of the communications network 100 is shown in FIG. 2a. In this example, the logical components predictive function 222, network connection cache 226 and database 227 are located in the cloud infrastructure 101.

An example of some second embodiments of the communications network 100 is shown in FIG. 2b. In this example, the logical component database 227 is located in the cloud infrastructure 101, whereas the logical components predictive function 222 and network connection cache 226 are located in the RAN 150. In some of these embodiments, the logical components predictive function 222 and network connection cache 226 are located in nodes 110, such as base stations 111, 112, 113.

An example of some third embodiments of the communications network 100 are shown in FIG. 2c. In this example, the logical component database 227 is located in the cloud infrastructure 101, whereas the logical components predictive function 222 and network connection cache 226 are located in the CN 140.

An example of some fourth embodiments of the communications network 100 are shown in FIG. 2d. In this example, the logical component database 227 is located in the cloud infrastructure 101, whereas one or both of the logical components predictive function 222 and network connection cache 226 are located in the RAN 150. In some of these embodiments, one or both logical components network connection cache 226 and predictive function 222 are located in the communication device 121, 122.

In some embodiments herein, the request handler 223 may also be comprised in the RAN 150, such as e.g. in the network node 110. The network node 110 may be represented by the base station 111, 112, 113. Furthermore, the request handler 223 may also be comprised in the CN 140. In such embodiments, the interaction may be somewhat different since, in general, at the RAN 150 it is only possible to go up to MAC address when it comes to determining where to send a message. Corresponding alterations would therefore be made.

A related scenario of some embodiments herein may e.g. be the use of a look up table that maps a MAC address with a service request. Using an example of flight analytics, if an aeroplane with a particular engine lands, it typically needs to access an analytics function where it uploads a significant amount of information about its journey. Using the MAC address of the network interface, the MAC address may be added to a lookup table which will then be sent to the corresponding service. Over time, features of embodiments herein will pick this up as a request and therefore will be able to predict this. Without the use of a look up table it will take longer, since the system will have to wait until the MAC address resolves to an IP address and then to a service request.

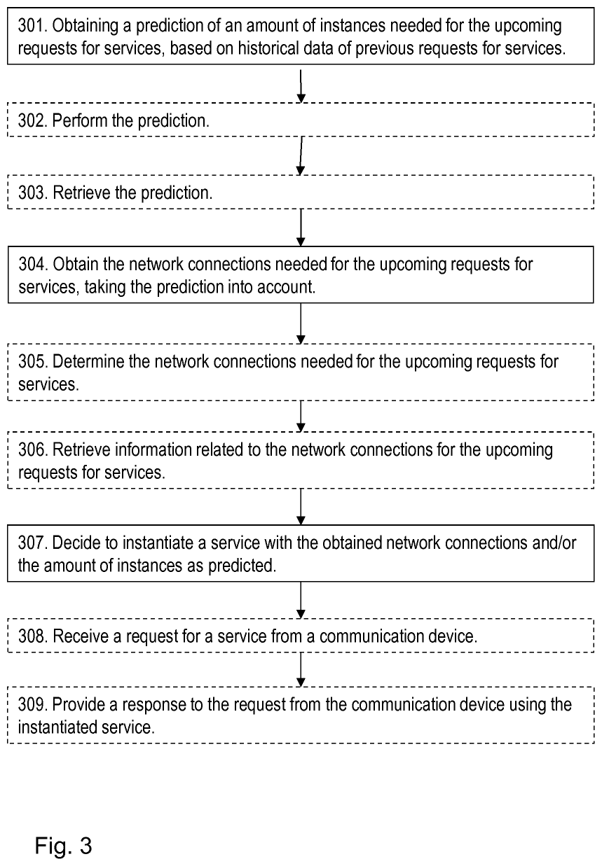

Example embodiments of a method performed by the network node 110 for handling one or more upcoming requests for one or more services from a communication device 121, 122 in a communications network 100 using a cloud infrastructure 101 will now be described with reference to a flowchart depicted in FIG. 3.

The method comprises the following actions, which actions may be taken in any suitable order. Actions that are optional are presented in dashed boxes in FIG. 3.

Action 301

As mentioned above, pre-loading functions contributes to reduced latency in the communications network 100.

Thus, according to the example scenario, in order to preload functions in an efficient manner a prediction of an amount of instances needed for the one or more upcoming requests for the one or more services, is obtained by the network node 110. The network node 110 may e.g. obtain a prediction of how many instances of a certain service function that should be instantiated in the next time unit. Time unit when used herein may refer to any unit of time, such as the next 5 minutes, the next 10 minutes, the next hour etc. depending on the kind of information available. Such information may e.g. be guided by other signals coming from operations or business functions. If there is an event that is irregular for example, the predictions may be based on the previous events if the time intervals between the events are ignored. Such information may be available to operations centres. In the example above relating to flight analytics, a flight schedule with plane models will improve the prediction since it is only needed to predict what occurs after the scheduled plane landing. In another example, it may be predicted what happens before landing.

According to embodiments herein, the prediction is based on historical data of previous requests for services. Such historical data may e.g. be an amount of service functions, docker containers or virtual machines that has previously been needed to serve a number of remote calls, such as requests for services, over time. The historical data may be compiled into a table that may be looked into when performing the prediction.

The amount of instances may in some embodiments herein comprise an amount of instances of a service function.

In some embodiments, the prediction obtained by the network node 110 may further comprise a prediction of when a certain service function will be needed, and/or how many resources need to be allocated for the service.

Action 302

In some embodiments, the network node 110 may obtain the prediction by performing the prediction of the amount of instances needed for the one or more upcoming requests for the one or more services. The prediction may be performed by a machine learning process, such as e.g. a reinforcement-based machine learning process.

The prediction may be given as a number that may be either negative, positive or zero. Negative numbers in this circumstance would indicate that the result of the prediction is that an instance of a service function should be removed.

In some embodiments herein, the result of the prediction may be multiple instances of the same reinforcement learning algorithm, but trained with different data that belong to a certain service.

In some embodiments herein a model-free reinforcement learning algorithm, such as multiple reinforcement learning Q-learning, largely corresponding to neural networks, may be used instead of attempting to create global models. Furthermore, re-use of the prediction may be possible by annotating a serverless function with metadata and then applying vector space similarity to find similar functions. Such possibilities may be useful for bootstrapping purposes.

Action 303

In some embodiments, the network node 110 may obtain the prediction by retrieving the prediction of the amount of instances needed for the one or more upcoming requests for the one or more services. The network node 110 may e.g. retrieve the prediction from another network node in the communications network and/or from a communication device 121, 122.

As mentioned above, the predictive function 222 that is responsible for performing the prediction may e.g. be located in the cloud infrastructure 101; in the RAN 150, such as in a base station 111, 112, 113; in the CN 140; and/or in the communication device 121, 122.

Action 304

According to the example scenario, the network node 110 obtains the network connections needed for the upcoming requests for services, taking the prediction into account.

Such network connections obtained may e.g. be persistent network connections as defined above. Persistent network connections are unique objects and therefore a distributed hash table is a type of data structure that may be used for the purposes of embodiments herein. Such a data structure may also store the persistent connections. Using a hash table, each connection may be assigned a unique ID, also referred to as a key, and a value that would be OS related information pertinent to the networking stack, which would allow for the connection to be resumed.

In some embodiments herein, external connections are obtained, which may or may not be available over time, and therefore a network node 110 such as a persistent connection curator may be introduced. The persistent connection curator may periodically check if the connections are still active and, if they are not, erase them from the hash table.

Obtaining network connections, when used herein, comprises obtaining a handle to the network connections. This may mean that embodiments herein may relate to cases when network connections are established and waiting in some kind of a pool, and/or when network connections still need to be established, such as on-demand.

Action 305

In some embodiments, the network node 110 may obtain the network connections by determining the network connections needed for the one or more upcoming requests for the one or more services. This may be done by taking into account the prediction, and, if found to be necessary, add additional information. The process of determining the network connections needed may be performed by components such as the runtime component 225 and the network connection cache 226 in the network node 110. Corresponding network connections may e.g. be appended next to a service description implicitly or, through introspection, the compiler for the service may indicate any calls in the code of the service that may result in invocation of external services.

Action 306

In some embodiments, the network node 110 may obtain the network connections by retrieving information related to the network connections needed for the one or more upcoming requests for the one or more services. This may be done by a component such as the network connection cache 226, e.g. if connections that have expired need to be revived or re-created.

Furthermore, in this action, connections may be instantiated if they are not available.

Action 307

According to the example scenario, the network node 110 decides to instantiate a service with the obtained network connections and/or the amount of instances as predicted.

In an example embodiment, the decision to instantiate may be made by way of a direct request i.e. on-demand. In another example embodiment, the decision to instantiate may be made in an offline process, e.g. by being periodically triggered by an offline process.

In some embodiments herein, disclosing how many times a certain service should be instantiated may be the product of the machine learning algorithm.

Action 308

In some embodiments, the network node 110 may receive a request for one or more services from the communication device 121, 122.

The request may e.g. comprise a request to access a certain service, which service may depend on one or multiple service functions. It should be noted that the action 308d does not have to occur subsequently to the action 307. The same applies to action 308 below. As stated above, actions herein may be taken in any suitable order. Actions 308 and 309 may be said to be a part of an online process, which may occur before, at the same time as, or after the action 307. Furthermore, it should be understood that the actions 308 and 309 may be taken more than once, such as in a request-response loop

Action 309

In some embodiments, after having received a request for a service from the communication device 121, 122, the network node 110 may provide a response to the request from the communication device 121, 122 using the instantiated service.

In some embodiments, some of the actions may be performed in an offline process and some actions may be performed in an online process. The wording offline process is used herein in the sense that actions that are included in the offline process may be performed before, in parallel with, or in other respects in the background of, a particular request coming in to the network node 110, e.g. from the communication device 121, 122. The wording offline may e.g. be used to mean pre-demand or scheduled based on predicted demand. Correspondingly, the wording online process is used herein in the sense that actions that are performed in the online process are performed as a consequence of a request coming in to the network node 110, e.g. from the communication device 121, 122. The wording online may e.g. be used to mean on-demand, i.e. when the request comes.

It should be understood that offline process and online process are non-limiting terms that mean any process corresponding to the example processes described herein.

In some embodiments, a predictive component is provided in the overall lifecycle of onboarding a service function. Generally, onboarding a predictive component may comprise: a training phase, where a model is being trained with data; an evaluation phase where a model is evaluated for accuracy against a curated set of data; and then a deployment phase where a model goes online, meaning that it may receive external requests. This general approach applies to most machine learning models, in reinforcement learning these steps are performed on the spot in an active model.

The predictive component, in some embodiments performed by a machine learning process, may predict ahead of time how many instances of a certain service function that are needed and make them available to e.g. the communication device 121, 122. The amount of such instances may be autonomously downsized and/or upsized, e.g. as needed by the communication device 121, 122.

Moreover, the predictive component may consider the option of promoting a service function into a container in cases where greater isolation is needed. Greater isolation when used herein comprises the use of a separate physical node that supports container based deployments, thus benefiting from dedicated cgroup namespaces but at the same time suffering slightly, at least initially, if data transfer is needed while moving the hosting docker image from a registry to the corresponding node in the case where that image is not already there. In a general case, caches are used to alleviate such delays.

Consequently, the predictive component may also be used indirectly to setup and maintain any needed persistent connections required by the service function.

Thus, obtaining a prediction of an amount of instances needed for the one or more upcoming requests for the one or more services, based on historical data of previous requests for services; obtaining network connections needed for the one or more upcoming requests for one or more services, taking the prediction into account; and deciding to instantiate a service with the obtained network connections and/or the amount of instances as predicted, contributes to reduced latency in the communications network. Thereby, the performance of the communications network is improved.

The methods described above will now be further explained and exemplified and be described more in detail. The description below may refer to any embodiment above.

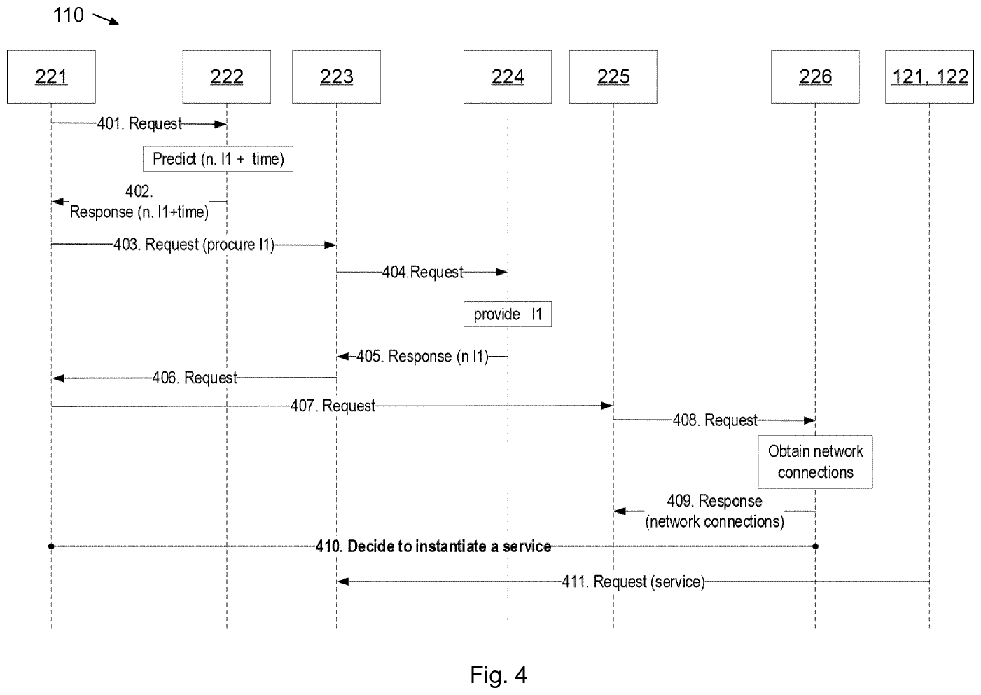

FIG. 4 depicts an example scenario of how service functions may be loaded according to some embodiments herein.

The actions herein, although portrayed sequentially, may be performed in any suitable order.

The first service function instance, referred to as I1, is used herein as a tool for explanation only. It should be understood that I1 may represent one or several service function instances and that the actions below would then be altered accordingly. Moreover, the term I1 may represent various instances of service functions, an amount of such functions, and/or needs related to service functions required for upcoming requests for services. Such needs may e.g. be a number of copies of a certain service function, a time when one or many particular service functions will be needed, network connections required for the service, and how many resources that will need to be allocated.

Furthermore, it should be understood that when the term network connection is used herein it may represent one or a plurality of network connections.

Furthermore, it should be recognized that the embodiments described herein are not necessarily coupled to specific operating systems or even specific environments such as e.g. Infrastructure as a Service, IaaS, environments.

In the example scenario, actions 501-510 below may be performed in an offline or online process, whereas action 511 may be performed in an online process. As mentioned above, the actions that are included in the offline process may be performed before, in parallel with, or in other respects in the background of, a particular request coming in to network node 110, e.g. from the communication device 121, 122. Correspondingly, the online process comprises actions that may be performed from the event where a request for a particular service is coming in, e.g. from any of the communication devices 121, 122.

According to the above, the network node 110, may obtain a prediction of an amount of instances needed for one or more upcoming requests for one or more services. Therefore, the cluster manager 221, sends (401) a request to the predictive function 222. In some embodiments herein, the request is for a prediction of which time a first service function instance I1, should be loaded, and how many instances of I1 that will be needed for the one or more upcoming requests for the one or more services.

Having received the request, the predictive function 222 performs the requested prediction, based on historical data of previous requests for services.

When the prediction has been performed, the predictive function 222 sends (402) a response to the cluster manager 221. In the example scenario, the response may comprise the result of the prediction. By the response, the cluster manager 221 is informed about the prediction, e.g. at which time the I1 should be loaded and how many instances of the I1 that will be needed for the one or more upcoming requests for the one or more services. This action relates to Action 301, described above and depicted in FIG. 3.

Based on the received prediction, the cluster manager 221 sends (403) a request to the request handler 223, to procure a certain number of instances of an I1, related to the prediction. The prediction may be a negative number, which means that the procurement would be a removal of an instance of a service function. By way of the procurement, it is ensured that I1 is loaded in memory.

Upon receiving the request for procuring I1, the request handler 223 sends (404) a request to the function repository 224, to provide the I1 requested by the cluster manager 221. At the function repository 224 level, functions may simply be static binary data. This is since within the premise of the function repository the focus may primarily be on efficient storage and efficient network transfer. Therefore binary (serialized) representations may be used.

The function repository 224 provides the procured number of instances of the I1 and sends it in a response (405) to the request handler 223. The I1 may be a binary representation describing the metadata of the one or more service functions, which is useful information for finding out how to instantiate the one or more functions. Such information may e.g. comprise information about which software components are used, how many resources are needed such as (CPU/RAM) and any external network interfaces that may be required.

Having received the response from the function repository 224, the request handler 223 sends (406) a request to the cluster manager 221 to deploy runtime. Deploy runtime, when used herein means performing real instantiation of the serverless function, which means retrieving any required software from remote sources and creating running processes out of it for an operating system to manage.

The cluster manager 221 then sends (407) a request to deploy runtime to the runtime component 225. The runtime component may represent a function or a host of several functions and running one or a plurality of processes.

Thereafter, the runtime component 225 sends (408) a request to the network connection cache 226 to obtain persistent connections for I1. This action relates to Action 304, described above and depicted in FIG. 3. This action prompts the network connection cache 226 to obtain network connections needed for the one or more upcoming requests for the one or more services, taking the prediction into account.

The network connection cache 226 obtains and thereafter provides persistent connections in a response (409) to the runtime component 225.

When the requested number of instances of the I1 has been provided to the request handler 223, and the persistent connections have been provided to the runtime component 225, it may be decided (410) to instantiate a service with the obtained network connections and the amount of instances as predicted. This action relates to Action 307, described above and depicted in FIG. 3.

To make use of the previously performed actions, in this example scenario the communication device 121, 122 may send (411) a request for a service. This action may be said to start the online process and may relate to the one or more upcoming requests for one or more services, sent from the communication device 121, 122 to the network node 110.

As mentioned above, the logical components 200 may be comprised in the same or different network nodes 110, which network nodes 110 may in turn be comprised in the cloud infrastructure 101, the RAN 150 and/or the CN 140. Many variations of placements for the various logical components 200 are possible, exceeding those exemplified herein.

Terms such as service functions, lambda functions, virtual machines and docker containers may be used interchangeably herein. This means e.g. that the function repository 224 may be replaced by a docker registry or a virtual machine repository, such as the artifactory of JFrog™.

Machine Learning

As mentioned above, the prediction of the amount of instances needed for the one or more upcoming requests for the one or more services may be performed by a machine learning process, such as e.g. a reinforcement-based machine learning process.

Although different machine learning techniques may be utilized for the purposes herein, reinforcement-based machine learning has been identified as a suitable option. One of the benefits of this type of machine learning is that it does not require large quantities of data. Instead, a reinforcement-based machine learning process requires a reward function capable of rewarding the algorithm accordingly when it performs a prediction correctly. Such a prediction may e.g. be a prediction of a correct amount of instances of a service function.

To set up a reinforcement learning process, an agent may be built, that over time learns how to optimize a reward by e.g. maintaining a proper amount of active instances of service functions. This may be defined more formally by using a Markov Decision Process (MDP).

An MDP is a discrete time stochastic control process. It provides a mathematical framework for modeling decision making in situations where outcomes are partly random and partly under the control of a decision maker.

An MDP comprises a set of possible states, S, from which an agent will get experience s at any time, and a set of all possible actions A which the agent may take at any time a.

In embodiments herein the action would e.g. be either to add or remove an instance of a service function.

In embodiments herein, given a state action pair (s, a), the transition probability T to a new state s′ may be defined by T(s, a) and the reward R may be given by R(s, a).

In general terms, Pₐ(S, s′) may be used to express the probability that action a in state s at time t will lead to state s′ at time t+1. Correspondingly, the reward may be expressed in general terms as Rₐ(s, s′), i.e. the expected immediate reward received after transitioning from state s to state s′.

As such, at any time in an MDP, an agent is given a state s, takes action and receives a new state and reward.

In embodiments herein, the agent needs to know how many requests that exist for a certain service function, such as I1 discussed above, at a particular time of the day. Different levels of granularity may be considered, such as every half-hour, hour or every 4 hours, depending on how much accuracy is required.

Furthermore, the amount of active service functions needs to yield satisfactory results both in the present and in the future, so that frequent changes of the amount of active service functions may be avoided.

The chosen policy gradient in this case may e.g. make use of a buffer in order to collect multiple experiences at a time. Given that the available set of actions may be limited, it is possible to maintain this buffer in memory.

As described above, in some embodiments a machine learning process, in particular a reinforcement-based machine learning process such as an MDP may e.g. be used for predicting the amount of service functions, docker containers or virtual machines that are needed to serve a number of remote calls over time. This may be performed by reviewing a concise compilation of historical data, which may e.g. be a Q-table. The Q-table may be significantly smaller than the historical data itself and may therefore fit in memory.

Thus, by using a machine learning process, in particular a reinforcement-based machine learning process such as an MDP, predicting the amount of instances needed for the one or more upcoming requests for the one or more services is enabled. Thereby, the performance of a communications network will be improved.

In some embodiments herein, it is therefore provided that a self-learning approach may be utilized for determining when certain service functions, docker containers or virtual machines need to be allocated in order to serve remote calls. Remote calls when used herein may e.g. mean a remote request that fulfills a certain action, it may be any request originating from a remote system over a network. Embodiments herein e.g. focus on loading these service functions and not on resource allocation. The problem of resource allocation may be solved implicitly by using a hypervisor or a container orchestrator.

Using embodiments herein, the limitations found in serverless computing are alleviated since functions may be preloaded ahead of time. Additionally, persistent connections are used, thus reducing any latencies observed by a user making remote calls.

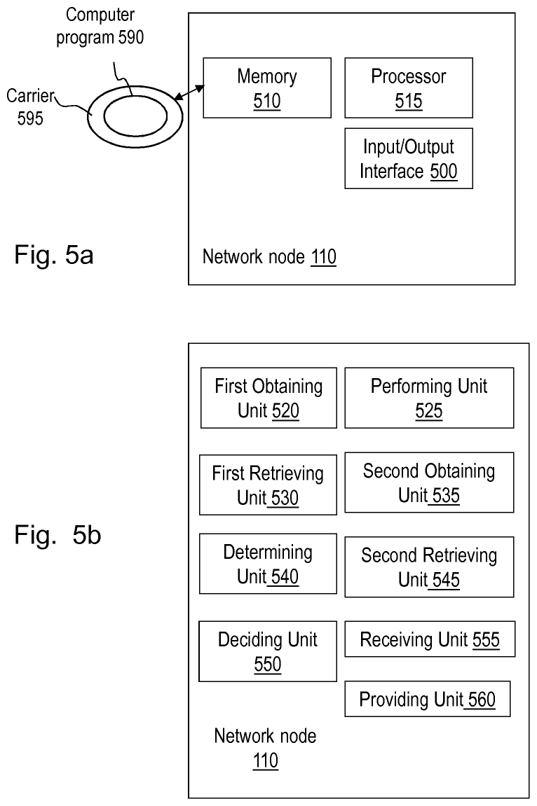

To perform the method actions above for handling one or more upcoming requests for one or more services from a communication device 121, 122 in a communications network 100 using a cloud infrastructure 101, the network node 110 may comprise the arrangement depicted in FIGS. 5a and 5b.

The network node 110 may comprise an input and output interface 500 depicted in FIG. 5a, configured to communicate e.g. with the communication device 121, 122 or another network node 110. The input and output interface 500 may comprise a wireless receiver (not shown) and a wireless transmitter (not shown).

The network node 110 may be configured to obtain, e.g. by means of the first obtaining unit 520 in the network node 110, a prediction of an amount of instances needed for the one or more upcoming requests for the one or more services, based on historical data of previous requests for services.

The amount of instances may be adapted to comprise an amount of instances of a service function.

The prediction of the amount of instances needed for the one or more upcoming requests for the one or more services may be further adapted to comprise a prediction of when a certain service function will be needed, and/or how many resources need to be allocated for a service.

The prediction of the amount of instances needed for the one or more upcoming requests for the one or more services, may be adapted to be performed by a machine learning process, such as a reinforcement-based machine learning process.

The network node 110 may be further configured to obtain, e.g. by means of the second obtaining unit 535 in the network node 110, network connections needed for the one or more upcoming requests for the one or more services, taking the prediction into account.

The network node 110 may be further configured to decide, e.g. by means of the deciding unit 550 in the network node 110, to instantiate a service with the obtained network connections and/or the amount of instances as predicted.

The network node 110 may be further configured to receive, e.g. by means of the receiving unit 555 in the network node 110, from the communication device 121, 122, a request for the one or more services.

The network node 110 may be further configured to provide, e.g. by means of the providing unit 560 in the network node 110, a response to the request from the communication device 121, 122 using the instantiated service.

The network node 110 may be further configured to obtain the prediction of network connections by being configured to perform the prediction, e.g. by means of the performing unit 525 in the network node 110, and/or retrieve the prediction, e.g. by means of the first retrieving unit 530 in the network node 110.

The network node 110 may be further configured to obtain the network connections needed for the upcoming requests for services, taking the prediction into account, by being configured to determine, e.g. by means of the determining unit 540 in the network node 110, the network connections needed for the one or more upcoming requests for the one or more services, and/or retrieve, e.g. by means of the second retrieving unit 545 in the network node 110, information related to the network connections needed for the one or more upcoming requests for the one or more services.

The network node 110 may be further configured to obtain the prediction of the amount of instances needed for the upcoming requests for services, obtain the network connections needed for the upcoming requests for services, and decide to instantiate a service with the obtained network connections and/or the amount of instances as predicted, in an offline process. The network node 110 may be further configured to receive the request for a service, and provide the response to the request from the communication device 121, 122 using the instantiated service, in an online process.

The embodiments herein may be implemented through a respective processor or one or more processors, such as a processor 515 of a processing circuitry in the network node 110 depicted in FIG. 5a, together with a respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 510 comprising one or more memory units to store data on. The memory 510 comprises instructions executable by the processor in the network node 110.

The memory 510 is arranged to be used to store e.g. predictions of an amount of instances needed for one or more upcoming requests for one or more services, information related to the network connections needed for the one or more upcoming requests for the one or more services, threshold values, data packets, data, configurations and applications to perform the methods herein when being executed in the network node 110.

The units in the network node 110 mentioned above may refer to a combination of analogue and digital circuits, and/or one or more processors configured with software and/or firmware, e.g. stored in the network node 110 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

In some embodiments, a computer program 590 comprises instructions, which when executed by the at least one processor 515 causes the at least one processor of the network node 110 to perform the actions above.

In some embodiments, a carrier 595 comprises the computer program 590, wherein the carrier 595 is one of an electronic signal, an optical signal, an electromagnetic signal, a magnetic signal, an electric signal, a radio signal, a microwave signal, or a computer-readable storage medium.

Further Extensions and Variations

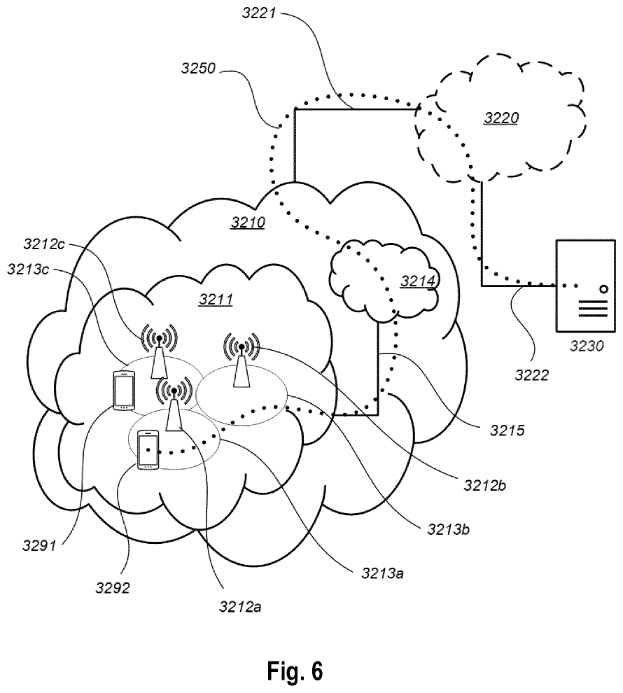

With reference to FIG. 6, in accordance with an embodiment, a communication system includes a telecommunication network 3210 such as the communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a Non-AP STA 3291 located in coverage area 3213c is configured to wirelessly connect to, or be paged by, the corresponding base station 3212c. A second UE 3292 e.g. the first or second radio node 110, 120 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

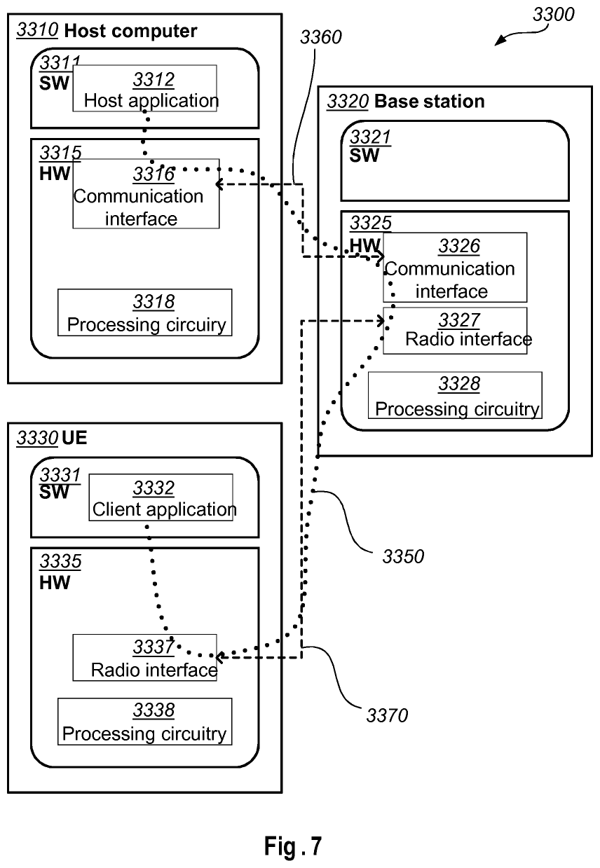

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

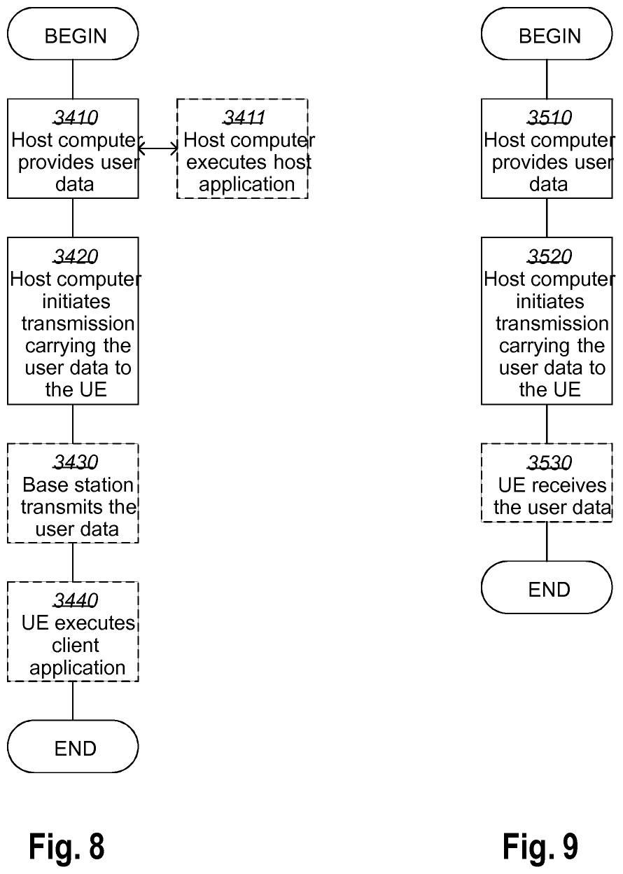

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 8 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 9 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

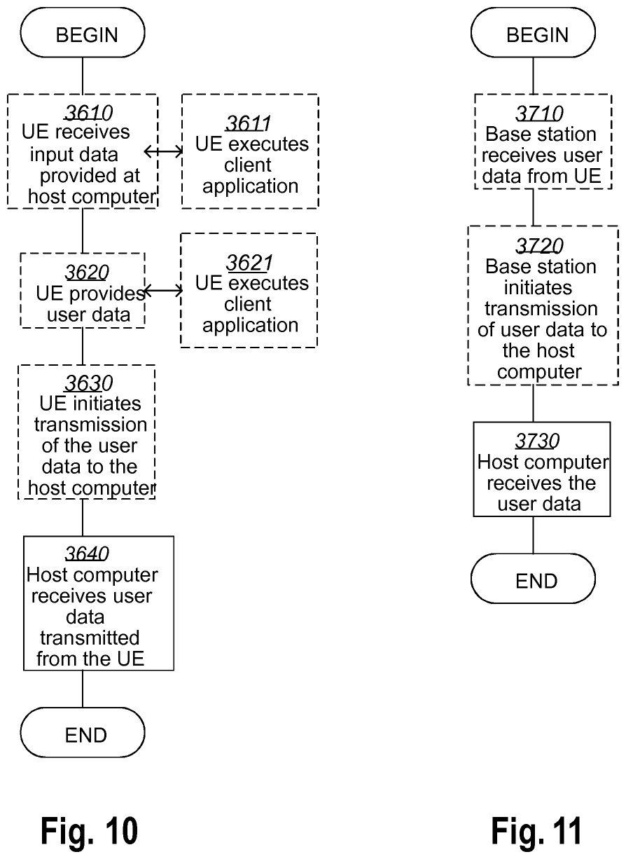

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 10 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 6 and FIG. 7. For simplicity of the present disclosure, only drawing references to FIG. 11 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1.-20. (canceled)

21. A method performed by a network node for handling one or more upcoming requests for one or more services from a communication device in a communications network using a cloud infrastructure, the method comprising:
obtaining a prediction of an amount of instances needed for the one or more upcoming requests for the one or more services, based on historical data of previous requests for services;
obtaining network connections needed for the one or more upcoming requests for the one or more services, taking the prediction into account; and
deciding to instantiate a service with the obtained network connections and/or the amount of instances as predicted.

22. The method according to claim 21, further comprising:
receiving, from the communication device, a request for the one or more services, and
providing a response to the request from the communication device using the instantiated service.

23. The method according to claim 21, wherein the obtaining the prediction comprises any one or more out of:
performing the prediction, and/or
retrieving the prediction.

24. The method according to claim 21, wherein the obtaining of the network connections needed for the upcoming requests for the one or more services, taking the prediction into account, comprises any one or more out of:
determining the network connections needed for the one or more upcoming requests for the one or more services, and/or
retrieving information related to the network connections needed for the one or more upcoming requests for the one or more services.

25. The method according to claim 22, wherein the obtaining the prediction of the amount of instances needed for the upcoming requests for the one or more services, the obtaining of the network connections needed for the upcoming requests for the one or more services, and the deciding to instantiate a service with the obtained network connections and/or the amount of instances as predicted, are performed in an offline process, and wherein the receiving of the request for the one or more services and the providing the response to the request from the communication device using the instantiated service, are performed in an online process.

26. The method according to claim 21, wherein the amount of instances comprises an amount of instances of a service function.

27. The method according to claim 21, wherein the prediction of the amount of instances needed for the one or more upcoming requests for the one or more services, is performed by a machine learning process.

28. The method according to claim 27, wherein the machine learning process is a reinforcement-based machine learning process.

29. The method according to claim 21, wherein the prediction of the amount of instances needed for the one or more upcoming requests for the one or more services, obtained by the network node, further comprises a prediction of:
when a certain service function will be needed, and/or
how many resources need to be allocated for the one or more services.

30. A network node configured to handle one or more upcoming requests for one or more services from a communication device in a communications network using a cloud infrastructure, the network node comprising processing circuitry configured to:
obtain a prediction of an amount of instances needed for the one or more upcoming requests for the one or more services, based on historical data of previous requests for services;
obtain network connections needed for the one or more upcoming requests for the one or more services, taking the prediction into account; and
decide to instantiate a service with the obtained network connections and/or the amount of instances as predicted.

31. The network node according to claim 30, the processing circuitry further being configured to:
receive, from the communication device, a request for the one or more services, and
provide a response to the request from the communication device using the instantiated service.

32. The network node according to claim 30, wherein the processing circuitry is configured to obtain the prediction of network connections by:
performing the prediction, and/or
retrieving the prediction.

33. The network node according to claim 30, wherein the processing circuitry is configured to obtain the network connections needed for the upcoming requests for the one or more services, taking the prediction into account, by:
determining the network connections needed for the one or more upcoming requests for the one or more services, and/or
retrieving information related to the network connections needed for the one or more upcoming requests for the one or more services.

34. The network node according to claim 31, wherein the processing circuitry is configured to obtain the prediction of the amount of instances needed for the upcoming requests for the one or more services, obtain the network connections needed for the upcoming requests for the one or more services, and decide to instantiate a service with the obtained network connections and/or the amount of instances as predicted, in an offline process, and wherein the processing circuitry is configured to receive the request for a service and provide the response to the request from the communication device using the instantiated service, in an online process.

35. The network node according to claim 30, wherein the amount of instances comprises an amount of instances of a service function.

36. The network node according to claim 30, wherein the processing circuitry is configured to perform the prediction using a machine learning process.

37. The network node according to claim 36, wherein the machine learning process is a reinforcement-based machine learning process.

38. The network node according to claim 30, wherein the prediction is a prediction of:
when a certain service function will be needed, and/or
how many resources need to be allocated for a service.

39. A non-transitory computer-readable medium on which is stored computer program code that, when executed by one or more processors of a network node, cause the network node to:
obtain a prediction of an amount of instances needed for one or more upcoming requests for one or more services from a communication device in a communications network, based on historical data of previous requests for services;
obtain network connections needed for the one or more upcoming requests for the one or more services, taking the prediction into account; and
decide to instantiate a service with the obtained network connections and/or the amount of instances as predicted.
